(19) United States
(12) Patent Application Publication
(10) Pub. No.: US 2013/0033362 A1
(43) Pub. Date: Feb. 7, 2013

(54) APPROACH AND/OR A CONTACT DETECTION DEVICE, ASSOCIATED METHOD AND VEHICLE DOOR HANDLE

(71) Applicant: Xavier HOURNE, Cugnaux (FR)

(72) Inventor: Xavier HOURNE, Cugnaux (FR)

(73) Assignees: CONTINENTAL AUTOMOTIVE GMBH, Hannover (DE); CONTINENTAL AUTOMOTIVE FRANCE, Toulouse (FR)

(21) Appl. No.: 13/561,109

(22) Filed: Jul. 30, 2012

(30) Foreign Application Priority Data
Aug. 3, 2011 (FR) 1102430

(51) Int. Cl. G05B 19/00

(52) U.S. Cl. 340/5.72

(57) ABSTRACT

A device (2) for an approach and/or a contact detection, includes a capacitive sensor (3) designed to be mounted in a handle (1) of a door (5) of a vehicle in order to detect the presence of the hand or of a portion of the hand of a user in a first zone (10), called the unlocking zone, situated between the handle (1) and the door (5) of the vehicle and a second zone (11), called the locking zone, situated to the outside of the handle (1) on the side opposite to the door (5). A control circuit (4) grounds the locking electrode (16) associated with the locking zone (11) when the control circuit (4) triggers a detection measurement (U) in the unlocking zone (10) of the handle (1) with the aid of the unlocking electrode (15).

The invention relates to an approach and/or a contact detection device and the associated method. The invention finds a particularly advantageous application in the field of door handles for motor vehicles.

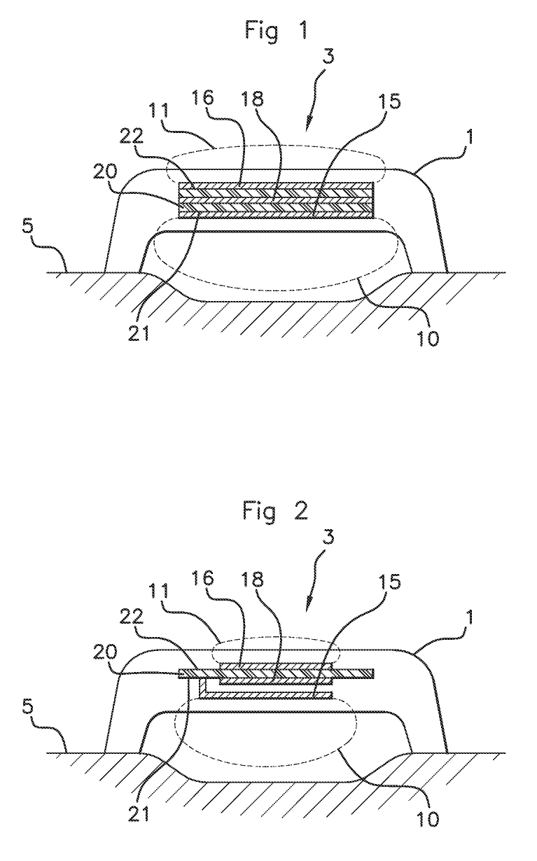

Approach and/or contact detection devices are known that are shown in FIGS. 1 and 2 comprising a capacitive approach and/or contact sensor 3 designed to be incorporated into a handle 1 of a door 5 of a vehicle. This sensor 3 makes it possible to detect the presence of the hand or of a portion of the hand (usually one or more fingers) of a user in a zone 10, called the unlocking zone, situated between the handle and the door 5 of the vehicle and in a zone 11, called the locking zone, situated to the outside of the handle 1 on the side opposite to the door 5.

When the presence of the hand or of a portion of the hand of the user is detected in the unlocking zone 10, the doors of the vehicle are unlocked. When the presence of the hand or of a portion of the hand of the user is detected in the locking zone 11, the doors of the vehicle are locked. For this purpose, the approach and/or contact sensor 3 comprises at least one detection electrode 15, called the unlocking electrode, associated with the unlocking zone 10, and one detection electrode 16, called the locking electrode, associated with the locking zone 11.

In order to prevent an undesirable unlocking of the doors of the vehicle when a hand passes close to the handle 1, the detection range of the unlocking electrode 15 must not be too great. In order to limit the detection range of the unlocking electrode 15, the capacitive approach and/or contact sensor 3 comprises a ground plane 18 (or a low-frequency antenna, used to recognize the hands-free access badge carried by the user) positioned between the unlocking electrode 15 and the front face of the handle 1. This ground plane 18 is designed to block the electrostatic field generated by the electrode 15, which reduces the detection range of this electrode 15. The ground plane 18 is therefore used to limit the unlocking zone 10 to a zone situated between the handle 1 and the door 5.

FIG. 1 shows a printed circuit 20 supporting the locking electrode 16 on its front face 22 and the unlocking electrode 15 on its rear face 21. The ground plane 18 is incorporated into the circuit 20 between the locking electrode 16 and the electrode 15. Such a configuration notably creates a considerable thickness of the sensor 3 and high fabrication costs. Moreover, it makes fabrication of the sensor 3 complex because of the high number of parts used.

Another known system shown in FIG. 2 comprises a ground plane 18 supported by the rear face 21 of the printed circuit 20. The locking electrode 16 is supported by the front face 22 and the unlocking electrode 15 is connected to the rear face 21 by means of a linking part 19. The thickness of such a system is less than that of FIG. 1 but nevertheless remains considerable. Moreover, this configuration involves considerable fabrication costs and a mounting of the sensor 3 that is difficult to achieve by due to notably of the high number of components used.

We also note that the positioning of the ground plane 18 which is very close to the electrodes 15 and 16 disrupts the measurements taken by the latter.

The main object of the invention is to solve at least one of the problems posed by the existing systems.

Accordingly, the invention relates to an approach and/or a contact detection device, comprising a capacitive approach and/or contact sensor and a control circuit, said device being designed to be mounted in a handle of a door of a vehicle in order to detect the presence of the hand or of a portion of the hand of a user in a first zone, called the unlocking zone, situated between the handle and the door of the vehicle and a second zone, called the locking zone, situated to the outside of the handle on the side opposite to the door, the capacitive approach and/or contact sensor comprising a detection electrode, called the unlocking electrode, associated with the unlocking zone of the handle, and at least one detection electrode, called the locking electrode, associated with the locking zone of the handle. The invention lies in the fact that the control circuit grounds the locking electrode associated with the locking zone when the control circuit triggers a detection measurement in the unlocking zone of the handle by means of the unlocking electrode.

According to one embodiment, the control circuit grounds the unlocking electrode associated with the unlocking zone when the control circuit triggers a detection measurement in the locking zone of the handle, by means of the locking electrode.

According to one embodiment, the control circuit regularly triggers a detection measurement in the unlocking zone by means of the unlocking electrode, and a detection measurement in the locking zone by means of the locking electrode, the detection measurement in the locking zone being taken between two successive detection measurements in the unlocking zone, the period between two successive detection measurements taken in the locking zone being longer than the period between two successive detection measurements in the unlocking zone.

According to one embodiment, the period between two successive detection measurements taken in the unlocking zone is between 15 and 20 milliseconds and the period between two successive detection measurements taken in the locking zone is between 45 and 60 milliseconds.

In one embodiment, the device comprises a first locking electrode associated with a first locking zone, and at least one second locking electrode associated with a second locking zone, each locking zone being associated with a given locking level.

According to one embodiment, the control circuit grounds all the detection electrodes that are not participating in the measurement when said control circuit triggers a detection measurement in a locking zone or unlocking zone by means of the corresponding detection electrode.

According to one embodiment, the control circuit regularly triggers a detection measurement in the unlocking zone by means of the unlocking electrode and a detection measurement for each locking zone by means of the first locking electrode and the second locking electrode, the detection measurements in the locking zones being taken one after the other and between two successive detection measurements taken in the unlocking zone.

According to one embodiment, the periods between two successive detection measurements taken respectively in the first and second locking zones are longer than a period between two successive detection measurements taken in the unlocking zone.

According to one embodiment, a period between two successive detection measurements in the unlocking zone is between 15 and 20 milliseconds, a period between two successive detection measurements in the first locking zone is between 45 and 60 milliseconds, a period between two successive detection measurements in the second locking zone is between 45 to 60 milliseconds.

According to one embodiment, periods between two successive detection measurements taken in the locking zones are identical.

According to one embodiment, the range of the unlocking electrode is between 10 mm and 15 mm.

According to one embodiment, the range of the locking electrode or electrodes is smaller than the range of the unlocking electrode.

The invention also relates to a vehicle door handle equipped with an approach and/or contact detection device.

The invention also relates to an approach and/or contact detection method used with an approach and/or contact detection device designed to be mounted in a door handle of a vehicle, this approach and/or contact detection device comprising a control circuit and a capacitive approach and/or contact sensor having a detection electrode, called the unlocking electrode, associated with an unlocking zone of the handle, and at least one detection electrode, called the locking electrode, associated with a locking zone of the handle. Since the method according to the invention uses the device described above, in this instance the method comprises a step of grounding the locking electrode associated with the locking zone when the control circuit triggers a detection measurement in the unlocking zone of the handle by means of the unlocking electrode.

According to one embodiment of the invention, the method also comprises a step of grounding the unlocking electrode associated with the unlocking zone when the control circuit triggers a detection measurement in the locking zone of the handle by means of the locking electrode.

The invention will be better understood on reading the following description and on examining the figures that accompany it. These figures are given only as an illustration and are in no way limiting of the invention. They show:

FIG. 1 (already described): a view in section of a door handle incorporating an approach and/or contact detection device according to the prior art having a ground plane positioned inside a printed circuit;

FIG. 2 (already described): a view in section of a door handle incorporating an approach and/or contact detection device according to the prior art having a ground plane supported by one of the faces of a printed circuit;

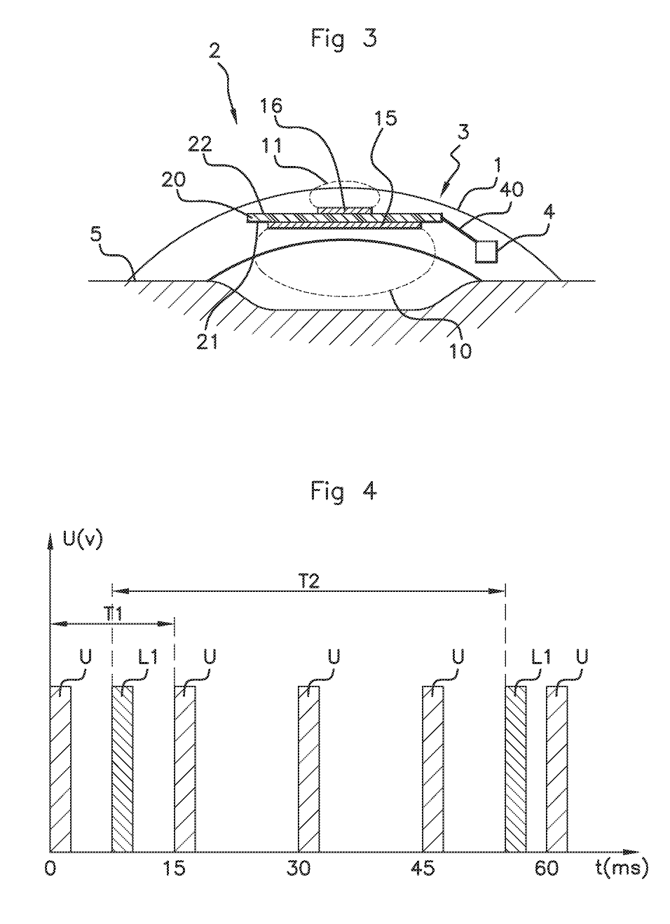

FIG. 3: a view in section of a door handle incorporating an approach and/or contact detection device with a single locking electrode according to a first embodiment of the invention;

FIG. 4: a graphic representation of the time management of the measurements of the approach and/or contact detection device of FIG. 3;

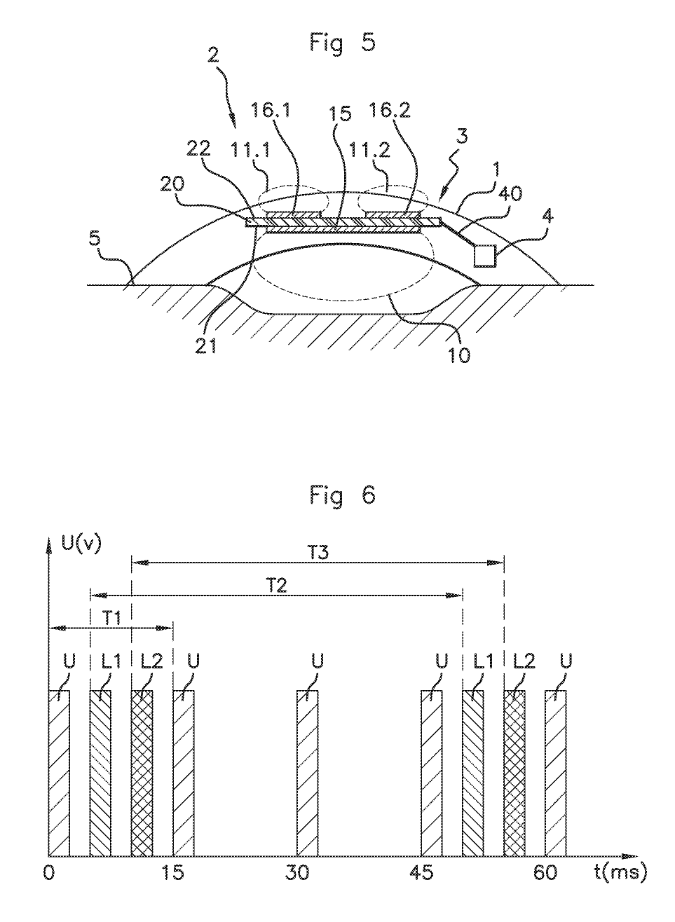

FIG. 5: a view in section of a door handle incorporating an approach and/or contact detection device furnished with two locking electrodes according to a second embodiment of the invention;

FIG. 6: a graphic representation of the time management of the measurements of the approach and/or contact detection device of FIG. 5.

Identical, similar or analogous elements retain the same reference from one figure to another.

FIG. 3 shows a view in section of a handle 1 of a door 5 in which an approach and/or contact detection device 2 is incorporated. This device 2 comprises a capacitive approach and/or contact sensor 3 having a first detection electrode 15, called the unlocking electrode, a second detection electrode 16, called the locking electrode, and a printed circuit 20 supporting these electrodes 15 and 16. Moreover, a control circuit comprising a microcontroller provides, as explained below, a dynamic management of the voltages applied to each locking and unlocking electrode 15, 16 and is connected, for example, via a wire connection 40 to the printed circuit on which the two locking and unlocking electrodes 15 and 16 are found.

More precisely, the printed circuit 20 supports the unlocking electrode 15 on one of its faces 21, called the rear face, orientated toward the door 5, and the locking electrode 16, on a face 22, called the front face, opposite to the rear face 21. The circuit 20 is therefore a circuit of the “two-layer” type because it supports tracks and corresponding components on each of its faces. The printed circuit 20 is positioned inside the handle 1.

One zone 10, called the unlocking zone, extending substantially between the handle 1 and the door 5, is associated with the unlocking electrode 15. The zone 10 corresponds to the detection zone of the unlocking electrode 15. A zone 11, called the locking zone, extending substantially to the outside of the handle 1 on the side opposite to the door 5 is associated with the locking electrode 16. The zone 11 corresponds to the detection zone of the locking electrode 16. The range of the unlocking electrode 15 is preferably between 10 mm and 15 mm. The range of the locking electrode 16 is usually smaller than the range of the unlocking electrode.

After having detected the presence of the hand or of a portion of the hand of the user in the unlocking zone (respectively the locking zone 11), the device 2 sends a signal by means of a radiofrequency antenna (not shown) to a hands-free system, of the badge type (not shown) carried by the user. After verification by the vehicle of the identifier of the badge carried by the user, that is to say after verification that the carrier of the badge is authorized, the vehicle automatically unlocks (or respectively locks) the vehicle.

Accordingly, as shown in FIG. 4, the control circuit 4 regularly triggers a detection measurement U in the unlocking zone 10. The period between two successive detection measurements U referenced T1 in FIG. 4 is very short, for example of the order of 15 to 20 milliseconds, in order to detect virtually instantaneously the presence of the hand or a portion of the hand of the user. For the whole duration of the detection measurement U in the unlocking zone 10, the invention proposes that the control circuit 4 grounds the locking electrode 16.

Specifically, when the locking electrode 16 is grounded by the control circuit 4, the locking electrode 16 has the same function as the ground plane of the sensors of the prior art, that is to say that the grounded locking electrode 16 blocks the electrostatic field generated by the unlocking electrode 15. This reduces the detection range of the unlocking electrode 15 to the zone situated between the handle 1 and the door 5 in order to prevent the undesired detection of a hand passing close to the handle 1. Moreover, the locking electrode 16 does not disrupt the detection measurements U taken by the unlocking electrode 15.

Moreover, the control circuit 4 regularly triggers a detection measurement L1 associated with the locking zone 11 between two measurements U. Advantageously, the period T2 between two successive detection measurements L1 is longer than the period T1 between two successive detection measurements U, which makes it possible to reduce the consumption of the device 2. Specifically, the user tolerates the detection taking longer for a door closure than for an opening. In one embodiment, T2 is between 45 and 60 milliseconds. For the whole duration of the detection measurement L1 in the locking zone 11, the invention proposes that the control circuit 4 grounds the unlocking electrode 15.

When the unlocking electrode 15 is grounded by the control circuit 4, the unlocking electrode 15 has the same function as the ground plane of the sensors of the prior art, that is to say that the grounding blocks the electrostatic field generated by the locking electrode 16. In addition to the fact that this reduces the detection range of the locking electrode 16, the electrostatic field of the grounded unlocking electrode does not disrupt the measurement L1 taken by the locking electrode 16.

Because the function of the ground plane of the sensors of the prior art is provided in the invention, successively by the locking electrode 16 and by the unlocking electrode 15, the sensor 3 does not require an additional ground plane positioned between said electrodes 15 and 16, as was the case in the prior art. Therefore, in the embodiment illustrated by FIG. 3, the sensor 3 advantageously has no additional ground plane between the electrodes 15 and 16, which simplifies the fabrication and effectively reduces the thickness of said sensor 3, thus making it easier to incorporate into the handle 2.

In a second embodiment shown in FIG. 5, the capacitive approach and/or contact sensor 3 detects the presence of the hand or of a portion of the hand of the user by means of the unlocking electrode 15 associated with the unlocking zone 10, of a first locking electrode 16.1 associated with a first locking zone 11.1 and of a second locking electrode 16.2 associated with a second locking zone 11.2. Each locking electrode 16.1, 16.2 corresponds to a different locking level.

“Locking level” means the possibility of selecting, for a given locking level, amongst all of the members that can move from one position to another (rear-view mirror, windows and optionally sunroof) or from a locked state to an unlocked state (doors, trunk), the members that it is desired to command to close, that is to say move from an unlocked state to a locked state or move from an open position to a closed position. In one example, the zone 11.1 corresponds to a locking of all the doors while the zone 11.2 corresponds to a locking of all the doors and to the closing of the windows, of the rear view mirrors, and optionally of the sunroof of the vehicle.

As shown in FIG. 6, the control circuit 4 regularly triggers a detection measurement U in the unlocking zone 10. The period between two successive detection measurements U referenced T1 in FIG. 6 is very short, for example of the order of 15 to 20 milliseconds, in order to detect virtually instantaneously the presence of the hand or of a portion of the hand of the user. For the whole duration of the detection measurement U in the unlocking zone 10, the invention proposes that the control circuit 4 grounds all the electrodes that are not involved in the measurement, that is to say the locking electrodes 16.1 and 16.2.

Furthermore, the control circuit 4 regularly triggers a detection measurement L1 in the locking zone 11.1 between two detection measurements U. The period T2 between two successive detection measurements L1 (here again longer than T1) is for example of the order of 45 to 60 milliseconds. For the whole duration of the detection measurement L1 in the locking zone 11.1, the control circuit 4 grounds the electrodes that are not involved in the measurement, that is to say the unlocking electrode 15 and the locking electrode 16.2.

The control circuit 4 regularly triggers a detection measurement L2 in the locking zone 11.2 between two measurements U after the measurement L1. The period T3 between two successive detection measurements L2 is for example of the order of 45 to 60 milliseconds. Preferably, the periods T2 and T3 are identical. For the whole duration of the detection measurement L2 in the locking zone 11.2, the invention proposes that the control circuit 4 grounds the electrodes that are not involved in the measurement, that is to say the unlocking electrode 15 and the locking electrode 16.1.

Thus, the control circuit 4 triggers a detection measurement L1, L2 for each locking zone 11.1, 11.2, one after the other and between two detection measurements U.

After having detected a presence in the unlocking zone 10 or in the locking zones 11.1, 11.2, the device 2 sends by means of a radiofrequency antenna a signal to a hands-free system of the badge type (not shown) carried by the user. After verification by the vehicle of the identifier of the badge carried by the user, that is to say after verification that the carrier of the badge is authorized, the vehicle automatically unlocks (or respectively locks) the vehicle.

Naturally, the invention is not limited to the embodiments described, and the number of locking zones and hence of locking electrodes varies depends on the number of locking levels (for example the locking of all the doors, the locking of all the doors and the closing of the windows and of the sunroof, etc.). Consequently, although only two locking electrodes have been shown in FIG. 5, the sensor 3 may comprise a number of locking electrodes that is higher than two corresponding to the number of locking levels desired by the manufacturer of the vehicle.

Similarly, the sensor 3 may also comprise a number of unlocking electrodes corresponding to the number of unlocking levels desired. This unlocking level corresponds to the command to open the selected members for a given locking level.

The control circuit 4 is shown in FIGS. 3 and 5 as being positioned inside the handle 1. However, in an equivalent manner, the circuit 4 could be incorporated into the printed circuit 20, or positioned inside the door 5, or elsewhere in the vehicle. In particular, the circuit 4 could form part of the control electronics of the vehicle or “vehicle computer”.

It should be noted that one and the same approach and/or contact detection device 2 may comprise several capacitive approach and/or contact sensors 3, for example positioned in different door handles 5 of the vehicle. Advantageously, one and the same control circuit 4 is then used to simultaneously control each of said approach and/or contact sensors 3.

Therefore, the device according to the invention makes it possible to dispense with an additional part, that is to say the ground plane 18 used in the prior art by judiciously using each electrode when it is not being used for detection as a ground plane by electrically grounding it.

1. A device (2) for an approach and/or a contact detection, comprising a capacitive sensor (3) and a control circuit (4), designed to be mounted in a handle (1) of a door (5) of a vehicle in order to detect the presence of the hand or of a portion of the hand of a user in a first zone (10), called the unlocking zone, situated between the handle (1) and the door (5) of the vehicle and a second zone (11), called the locking zone, situated to the outside of the handle (1) on the side opposite to the door (5), the capacitive sensor (3) comprising, for the detection in these two zones:
at least one detection electrode (15), called the unlocking electrode (15), associated with the unlocking zone (10) of the handle, and
at least one detection electrode (16), called the locking electrode (16), associated with the locking zone (11) of the handle, said electrodes being connected to the control circuit (4),
characterized in that the control circuit (4) grounds the locking electrode (16) associated with the locking zone (11) when the control circuit (4) triggers a detection measurement (U) in the unlocking zone (10) of the handle (1), by means of the unlocking electrode (15).

2. The device as claimed in claim 1, characterized in that the control circuit (4) grounds the unlocking electrode (15) associated with the unlocking zone (10) when the control circuit (4) triggers a detection measurement (L1) in the locking zone (11) of the handle (1), by means of the locking electrode (16).

3. The device as claimed in claim 2, characterized in that the control circuit (4) regularly triggers a detection measurement (U) in the unlocking zone (10) by means of the unlocking electrode (15), and a detection measurement (L1) in the locking zone (11) by means of the locking electrode (16), the detection measurement (L1) in the locking zone (11) being taken between two successive detection measurements (U) in the unlocking zone (10), the period (T2) between two successive detection measurements (L1) taken in the locking zone (11) being longer than the period (T1) between two successive detection measurements (U) in the unlocking zone (10).

4. The device as claimed in claim 1, characterized in that it comprises a first locking electrode (16.1) associated with a first locking zone (11.1), and at least one second locking electrode (16.2) associated with a second locking zone (11.2), each locking zone (11.1, 11.2) being associated with a given locking level.

5. The device as claimed in claim 4, characterized in that the control circuit (4) grounds all the detection electrodes (15, 16.1, 16.2) that are not participating in the measurement when said control circuit (4) triggers a detection measurement (U, L1, L2) in a locking zone (10) or unlocking zone (11.1, 11.2) by means of the corresponding detection electrode (15, 16.1, 16.2).

6. The device as claimed in claim 5, characterized in that the control circuit (4) regularly triggers a detection measurement (U) in the unlocking zone (10) by means of the unlocking electrode (15) and a detection measurement (L1, L2) for each locking zone (11.1, 11.2) by means of the first locking electrode (16.1) and the second locking electrode (16.2), the detection measurements (L1, L2) in the locking zones (11.1, 11.2) being taken one after the other and between two successive detection measurements (U) taken in the unlocking zone (10).

7. The device as claimed in claim 6, characterized in that the periods (T2, T3) between two successive detection measurements (L1, L2) taken respectively in the first and second locking zones (11.1, 11.2) are longer than a period (T1) between two successive detection measurements (U) taken in the unlocking zone (10).

8. The device as claimed in claim 6, characterized in that the periods (T2, T3) between two successive detection measurements (L1, L2) taken in the locking zones (11.1, 11.2) are identical.

9. A vehicle door handle furnished with an approach and/or contact detection device as claimed in claim 1.

10. A method for detecting approach and/or contact using the device as claimed in claim 1.

11. The device as claimed in claim 7, characterized in that the periods (T2, T3) between two successive detection measurements (L1, L2) taken in the locking zones (11.1, 11.2) are identical.
